(19) United States
(12) Patent Application Publication
(10) Pub. No.: US 2014/0166398 A1
(43) Pub. Date: Jun. 19, 2014

(54) Stabilized Hunting Stand

(71) Applicant: Steven Kirk Trickle, Thornville, OH (US)

(72) Inventor: Steven Kirk Trickle, Thornville, OH (US)

(21) Appl. No.: 13/715,881

(22) Filed: Dec. 14, 2012

(51) Int. Cl. A01M 31/02; E06C 7/18

(52) U.S. Cl. CPC A01M 31/02; E06C 7/188
USPC 182/111; 248/346.03; 248/545

(57) ABSTRACT

The present invention provides a stabilizer for a hunting stand, which is suitable for use with a ladder stand or a freestanding hunting stand. The stabilizer incorporates two upright members, longitudinal rungs, and a female threaded member joined to the base section of each upright. The stabilizer levels the stand by the use of threaded rods that are inserted into the upright members and are rotatable in the female threaded member. Support plates are hinged at the base of each threaded rod. Typically the stabilizer includes a connector atop each upright, such as connection tubes or swaged connection sections. A stabilizer for and freestanding hunting stand incorporates a first upright member with a connector such as a connection tube or a swaged section at an upper end of the upright member with a nut at the lower end. A threaded rod is rotatable in the nut and is connected to a support plate. Ladder stands incorporating the stabilizer are also disclosed. The stabilizer improves safety stability are to reduce injuries from falling from an unstable stand and when propping up the stands.

### CLAIM OF PRIORITY

This Application is Continuation in Pat of U.S. application Ser. No. 11/613275, filed Dec. 14, 2011 entitled “Improved Hunting Stand” having Steven K Trickle as inventor. All aspects of Application 11/613275 are hereby incorporated by reference.

### BACKGROUND

Hunting stands or tree stands are often used by hunters to provide a better view of surrounding territory. Hunting stands include freestanding tripod stands and ladder stands, which typically include two legs and rely upon a tree for stability. Typical ladder stands include an upright ladder section with a platform at the top end. A large number of deer stands are known, such as U.S. Pat. No. 5,242,030 which shows an easily foldable in the form of a back pack and is convertible into a carrier to facilitate in the removal of game. U.S. Pat. No. 6,334,508 shows a hunting stand rotatably connected to a first ladder section and a second ladder section rotatably connected to the first ladder section which can be locked in a deployed configuration for improved portability and ease of setup. Hunting stands that break into sections for improved portability were developed such as U.S. Pat. No. 3,630314, which shows a portable hunting stand with two sections where the rails of the upper ladder section include sockets so that the uprights of the lower ladder section fit into the sockets of the upper ladder section. Safety and stability are important considerations when using a hunting stand since injuries from falling from unstable stands as well as injuries when propping up ladder stands are common.

### SUMMARY

In accordance with embodiments of the present invention, the Stabilized Hunting Stand of the present invention provides stability for an installed hunting stand as well as improved safety when propping up a ladder stand against a tree or other support.

In accordance with embodiments of the present invention, a stabilizer for a hunting ladder stand is presented having first and second upright members, each having a base section and an upper section, a plurality of longitudinal rungs between the uprights, female threaded couplers joined to the base section of each upright and threaded rods connected by hinges support plates.

In accordance with an additional embodiment of the present invention, a stabilizer for a hunting stand including an upright member, a female threaded member joined to the upright, a threaded rod having a base section and a head section, the head section being rotatable in the female threaded member, a support plate; and a hinge rotatably connecting the base section to the support plate.

In accordance with an additional embodiment of the present invention, a stabilized hunting ladder stand is presented, including first and second upright members, each having a base section and an upper section, a hunter support section at the upper section, a plurality of longitudinal rungs, first and second female threaded couplers joined to the base section of each upright; and first and second threaded rods, each having a base section and a head section, the head section being inserted into an upright member and rotatable in the female threaded member.

### BRIEF DESCRIPTION OF THE DRAWINGS

A more complete appreciation of the invention and the many embodiments thereof will be readily obtained as the same becomes better understood by reference to the following detailed description when considered in connection with the accompanying drawings, wherein:

FIG. 1 illustrates an isometric view of a ladder stand and support in accordance with the present invention;

FIG. 2 illustrates an isometric disassembled view of a ladder stand and support in accordance with the present invention;

FIG. 3 illustrates an isometric view, partially cut away, of a hinge and height adjusting feature suitable for use in a ladder stand support in accordance with the present invention.

### DETAILED DESCRIPTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

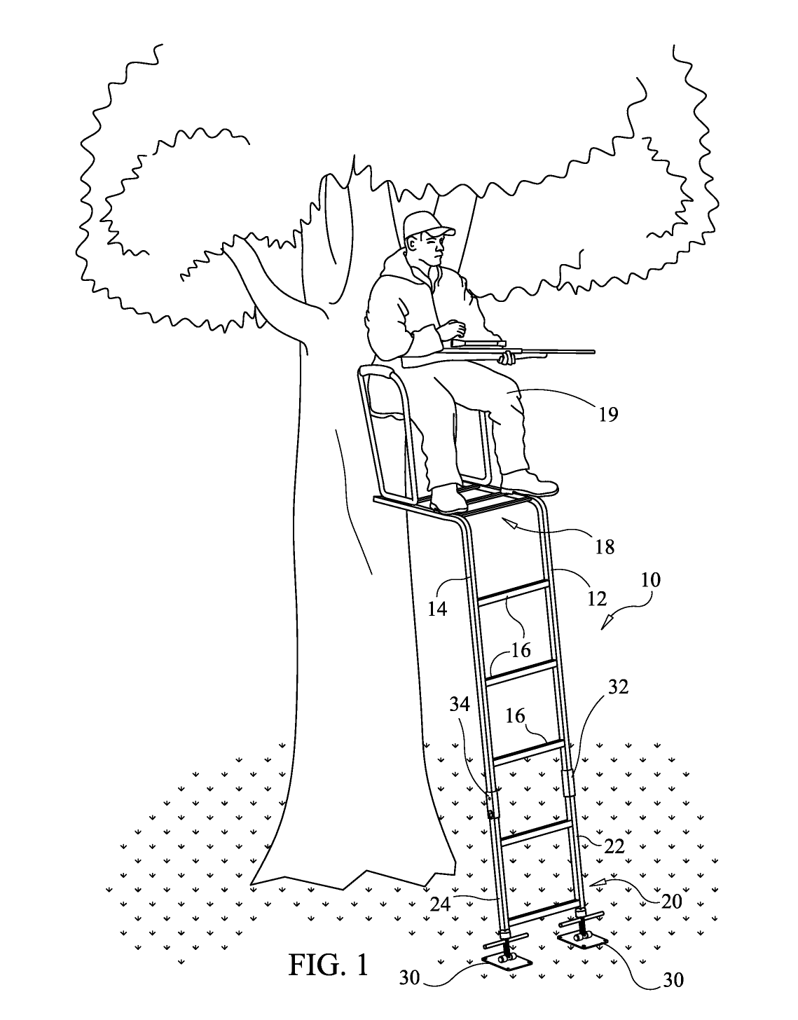

In FIG. 1, the improved hunting stand of the present invention is shown. The upper section 10 of the stand may include first upright rail 12 and second upright rail 14 with rungs 16. At the top end of the rails 12, 14 is a support section 18 on which a hunter 19 sits. At the lower end of upper section 10 are rail ends 12′, 14′ and one or more holes in each rail 36, 38. The base section 20 includes upright rails 22, 24 with joint section 32, 34 at the upper ends. While the tubing shown is square, any suitable tubing shape may be used. The joint sections 32, 34 may be pinned to rails 22, 24 with pins 40 or the joint sections may be welded or friction fit to the rails. Joint sections 32, 34 receive the ends 12′, 14′ of upper rails 12, 14 and may be pinned using holes 36, 38. At the base of each lower rail 22, 24 are adjustable support bases 30 that are independently adjustable to level the stand.

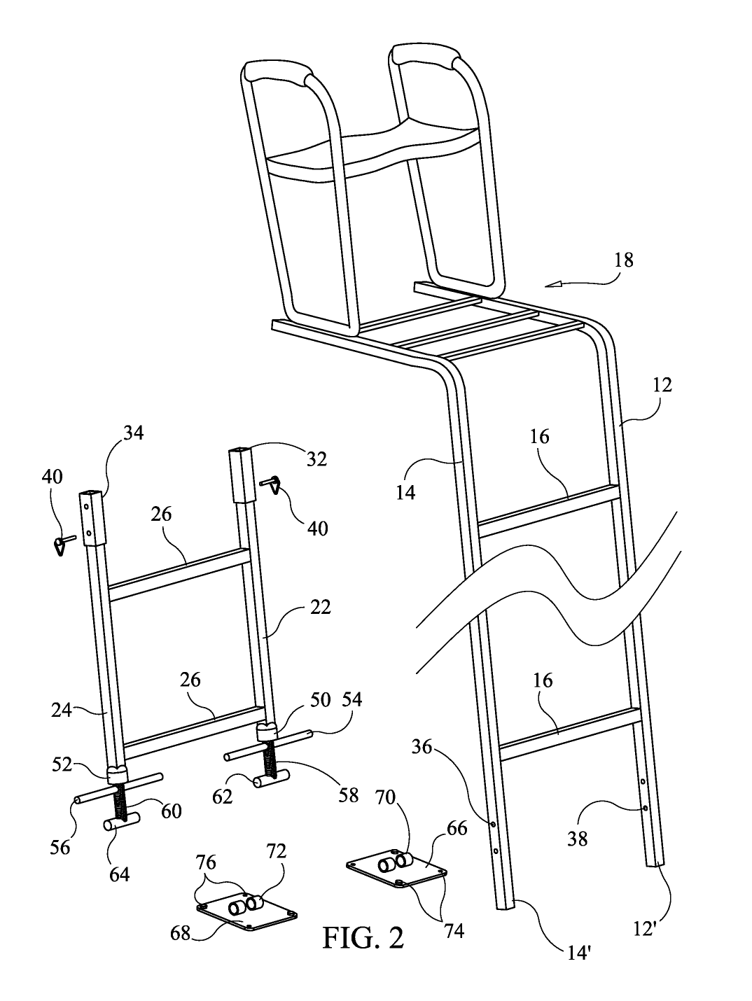

As seen in FIG. 2, the stabilized stand section of the present invention typically includes left and right rails 22, 24 and two rungs 26. At the top of rails 22, 24 are joint sections 32, 34 which may be welded, swaged or secured with pins 40. The joint sections 32, 34 mate with the base of a commercially available ladder stand. The stabilizer section adds height and security to an existing ladder stand. Each rail 22, 24 includes a threaded coupler 50, 52 fixed to the base with a threaded rod 58, 60 rotatable within the threaded coupler. Threaded rods 58, 60 may include handles 54, 56 to allow ease of rotation to adjust the height of each rail 22, 24 individually. At the base of each threaded rod 58, 60 is a hinge pin 62, 64 that rotates within knuckles 70, 72 on support plates 66, 68. As shown, the support plate may have a number of through holes 74, 76 that may receive a peg to secure the plate to the ground.

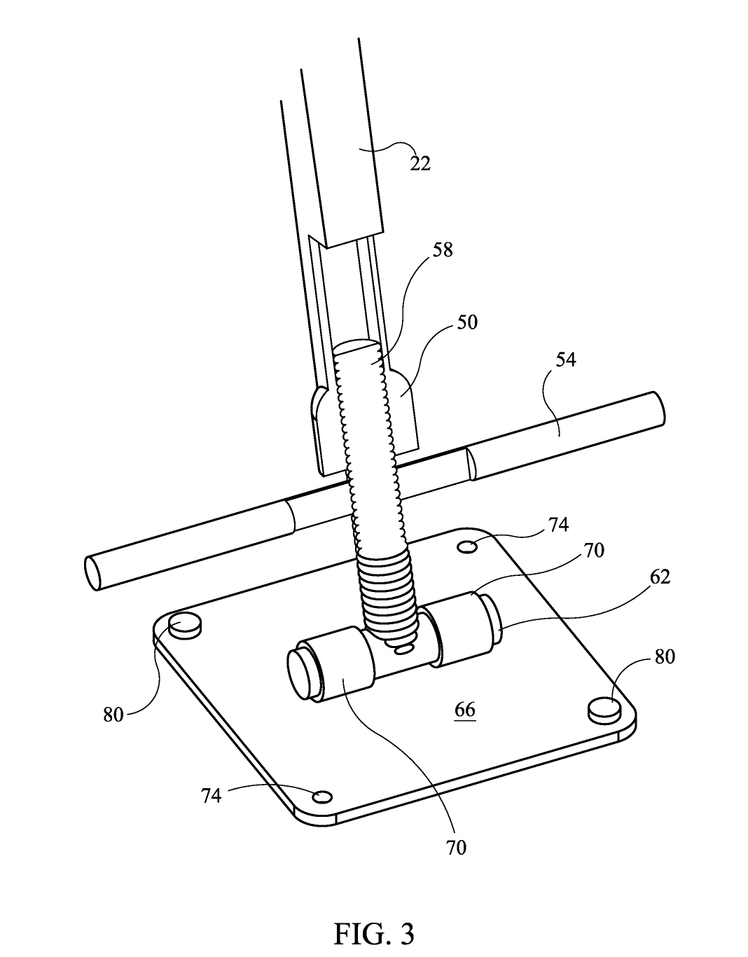

FIG. 3 shows a female threaded connector 50 is fixed to the base of rail 22 and the head of threaded rod 58 is inserted into the connector. A cross member 54 may be included to ease the rotation of threaded rod 58 to extended or withdrawn into connector 50 and upright 22. At the base of threaded rod 50 is a hinge that rotatably connects threaded rod 58 to support plate 66. Generally the hinge includes a pin 62 fixed to the base of threaded rod 58, and a knuckle 70 fixed to support plate 66. The support plate 66 preferably includes at least one through hole 74 though which pegs 80 may driven to secure plate to the ground.

In practice, the stand is assembled on the ground and the threaded rods are rotated to the approximate length required to level the stand once it is elevated. The plates are secured to the ground with pegs and the stand is elevated to lean against a tree. Once the stand is in the upright position the threaded rods may be rotated to fully level the stand. The level stand is much more secure than a tilted stand. Another benefit provided is that the legs of the stand are secured to the ground so the chances of the stand slipping and falling on the hunter during the elevation step are substantially reduced.

The present invention should not be considered limited to the specific examples described herein, but rather should be understood to cover all aspects of the invention. Various modifications, equivalent processes, as well as numerous structures and devices to which the present invention may be applicable will be readily apparent to those of skill in the art. Those skilled in the art will understand that various changes may be made without departing from the scope of the invention, which is not to be considered limited to what is described in the specification.

What is claimed is:

1. A stabilizer for a hunting ladder stands, comprising:
first and second upright members, each having a base section and an upper section;
a plurality of longitudinal rungs;
first and second female threaded couplers joined to the base section of each upright;
first and second threaded rods, each having a base section and a head section, the head section being inserted into an upright member and rotatable in the female threaded member;
first and second support plates;
a first hinge rotatably connecting the first threaded rod to the first support plate; and
a second hinge rotatably connecting the second threaded rod to the second support plate.

2. The stabilizer of claim 1, wherein each support plate comprises:
at least one through hole to allow the support plat to be secured to the ground.

3. The stabilizer of claim 1, wherein each support plate comprises:
at least one spike to allow the support plate to be secured to the ground.

4. The stabilizer of claim 1, wherein each support plate comprises:
four orifices to allow a peg to penetrate the support plate and secure the support plate to the ground.

5. The stabilizer of claim 1, further comprising:
first and second connection tubes positioned atop the upright members.

6. The stabilizer of claim 1, further comprising:
first and second swaged connection sections atop the upright members.

7. The stabilizer of claim 1, wherein each hinge further comprises:
a pin fixed to the base section of the threaded rod; and
at least one knuckle fixed to the support plate.

8. A stabilizer for a hunting stand, comprising:
an upright member;
a female threaded member joined to the upright;
a threaded rod having a base section and a head section, the head section being rotatable in the female threaded member;
a support plate; and
a hinge rotatably connecting the base section of the threaded rod and the support plate.

9. The stabilizer of claim 8, wherein the hinge further comprises:
a pin fixed to the base section of the threaded rod; and
at least one knuckle fixed to the support plate.

10. The stabilizer of claim 8, further comprising:
at least one through hole formed in the support plate to allow the support plat to be secured to the ground.

11. The stabilizer of claim 8, further comprising:
at least one spike formed in the support plate to allow the support plat to be secured to the ground.

12. The stabilizer of claim 8, further comprising:
four orifices formed in the support plate to allow a peg to penetrate the support plate and secure the support plate to the ground.

13. The stabilizer of claim 8, further comprising:
first and second spaced upright members.

14. The stabilizer of claim 13, further comprising:
first and second rungs positioned between and joined to the upright members.

15. The stabilizer of claim 13, further comprising:
first and second connection tubes positioned atop the upright members.

16. The stabilizer of claim 13, further comprising:
first and second swaged connection sections atop the upright members.

17. A stabilized hunting ladder stand, comprising:
first and second upright members, each having a base section and an upper section;
a hunter support section at the upper section;
a plurality of longitudinal rungs;
first and second female threaded couplers joined to the base section of each upright; and
first and second threaded rods, each having a base section and a head section, the head section being inserted into an upright member and rotatable in the female threaded member;
first and second support plates.

18. The stabilizer of claim 17, further comprising:
a first hinge rotatably connecting the first threaded rod to the first support plate; and
a second hinge rotatably connecting the second threaded rod to the second support plate.

19. The stabilizer of claim 17, wherein each support plate comprises:
at least one spike to allow the support plate to be secured to the ground.

20. The stabilizer of claim 17, wherein each hinge further comprises:
a pin fixed to the base section of the threaded rod; and
at least one knuckle fixed to the support plate.
